(19) United States
(12) Patent Application Publication
(10) Pub. No.: US 2006/0243217 A1
(43) Pub. Date: Nov. 2, 2006

(54) Aquatic exercising and conditioning device

(76) Inventor: David L. Patterson, Lebanon, OH (US)

Correspondence Address: DINSMORE & SHOHL LLP;One Dayton Centre, Suite 1300, One South Main Street, Dayton, OH, 45402-2023, US

(21) Appl. No.: 11/134,531

(22) Filed: May 20, 2005

Related U.S. Application Data
(63) Continuation of application No. 11/119,648, filed on May 2, 2005, now abandoned.

(51) Int. Cl. A01D 15/00

(52) U.S. Cl. 119/700

(57) ABSTRACT

An aquatic treadmill having a housing having a container configured to retain a liquid and sized to contain a horse within the container, a treadmill positioned along a lower portion of the container such that a horse upon entry into the container would stand upon the treadmill, and wherein the container has a decreasing cross sectional area.

### CROSS REFERENCE TO RELATED APPLICATIONS

This application is a continuation of U.S. patent application Ser. No. 11/119,648, filed May 2, 2005.

### BACKGROUND OF THE INVENTION

The present invention generally relates to an aquatic treadmill for horse. More particularly, the present invention relates to an aquatic treadmill for a horse including a container having a decreasing cross section and configured to contain a horse and a treadmill positioned along a lower portion of the container such that a horse upon entry into the container would stand upon the treadmill.

Conventional horse exercising and conditioning devices generally include a in ground pool that a horse is led into and then either walks or jogs against a current within the pool. In other conventional horse exercising devices, a horse is led up to a platform, which is then hydraulically lowered into a pool of water. Typically, these aquatic exercising devices are underground (e.g., below grade) and thus not transportable, portable, or movable.

Such animal exercising devices are typically rectangular in shape to provide sufficient space for an animal to exercise within the container. However, a rectangular shape requires a significant amount of liquid to properly fill the container with liquid sufficient enough to partially submerse a horse. Moreover, conventional animal exercising devices do not provide for an aquatic treadmill with an entrance and an exit that opens outwardly such that the animal does not have to move backwards to exit the container. In addition, when a horse steps upon a conventional treadmill, it has been common for such a treadmill to move or shift under the weight of the horse, ultimately scaring the horse. In addition, such animal exercising devices have not afforded a trainer the ability to easily observe an exercising animal's (e.g., a horse) gate (e.g., walk, trot, jog, run, canter, etc.) to see if the animal is favoring (i.e., leaning to one side) an injured appendage or recovery injury.

Accordingly, there is a need for improved aquatic treadmills.

### SUMMARY OF THE INVENTION

Accordingly, the present invention is intended to address and obviate problems and shortcomings and otherwise improve previous aquatic treadmills for horses.

One exemplary embodiment of the present invention is an aquatic treadmill for a horse having a container configured to retain a liquid and sized to contain a horse within the container, a treadmill positioned along a lower portion of the container such that a horse upon entry into the container would be standing upon the treadmill, and wherein the container has a decreasing cross sectional area.

Another exemplary embodiment of the present invention is an aquatic treadmill for a horse having a container configured to contain a horse partially within a retained liquid within the container. The container includes first and second end doors movably attached to the container opposite one another and configured to move outwardly from the container, and a treadmill positioned along a lower portion of this container.

Yet another exemplary embodiment of the present invention is an aquatic treadmill for a horse having a container configured to retain liquid, wherein the container includes first and second opposite sidewalls configured to have a decreasing cross section and first and second opposite, end doors movably attached to one of the sidewalls such that the end doors move outwardly from the container. In addition, the aquatic treadmill also includes a treadmill positioned along a lower portion of the container, an endless belt connected to the treadmill that moves between one of the end doors to the opposite end door, a motor configured to drive the belt, and a controller configured to operate the treadmill.

### BRIEF DESCRIPTION OF THE DRAWINGS

While the specification concludes with claims particularly pointing out and distinctly claiming the invention, it is believed the same will be better understood from the following description taken in conjunction with the accompanying drawings in which:

FIG. 1 is a perspective view of an exemplary embodiment of the aquatic treadmill according to the present invention;

FIG. 2 is a front elevational view of the aquatic treadmill illustrated in FIG. 1;

FIG. 3 is a top plan view of the aquatic treadmill illustrated in FIG. 1;

FIG. 4 is a side elevational view of the aquatic treadmill illustrated in FIG. 1; and

FIG. 5 is a detail schematic of an exemplary embodiment of the brake of the aquatic treadmill illustrated in FIG. 1.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE INVENTION

Reference will now be made in detail to various embodiments of the invention, examples of which are illustrated in the accompanying drawings, wherein like numerals indicate similar elements throughout the views.

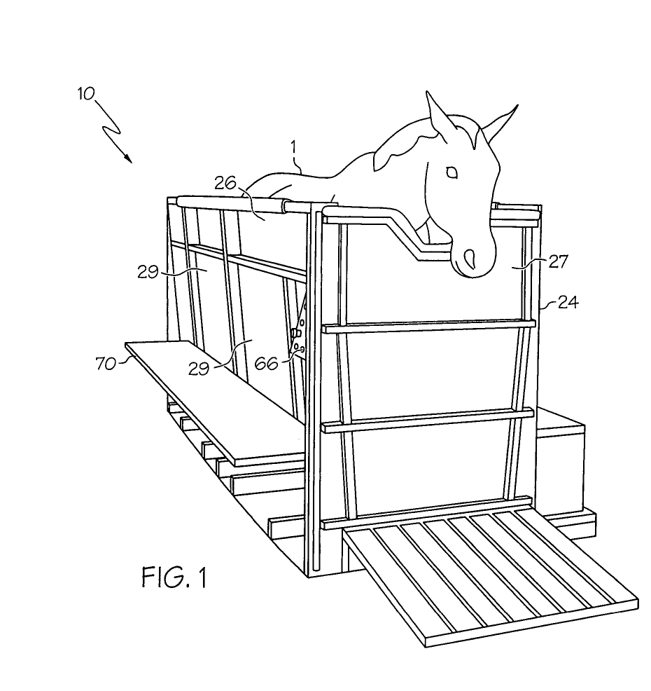

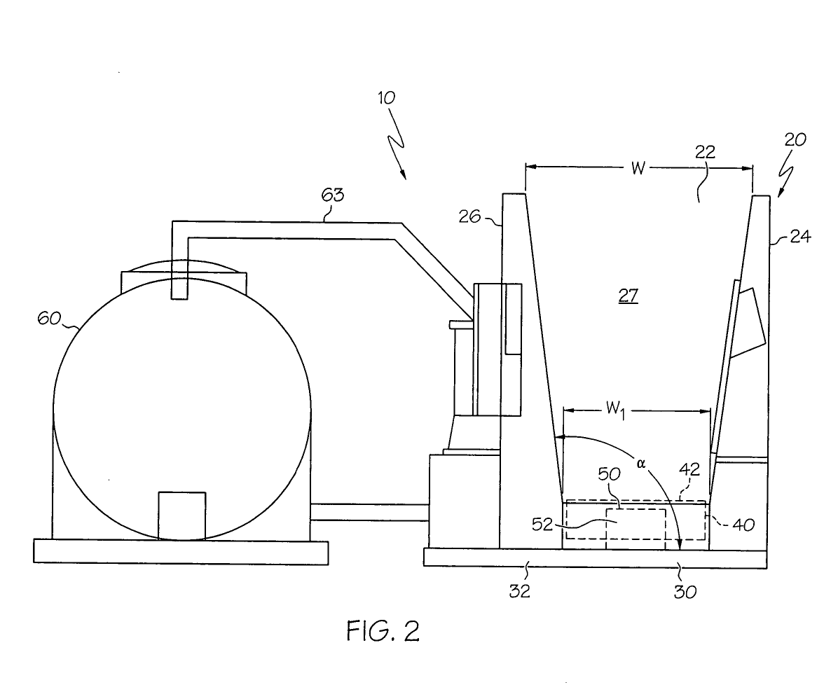

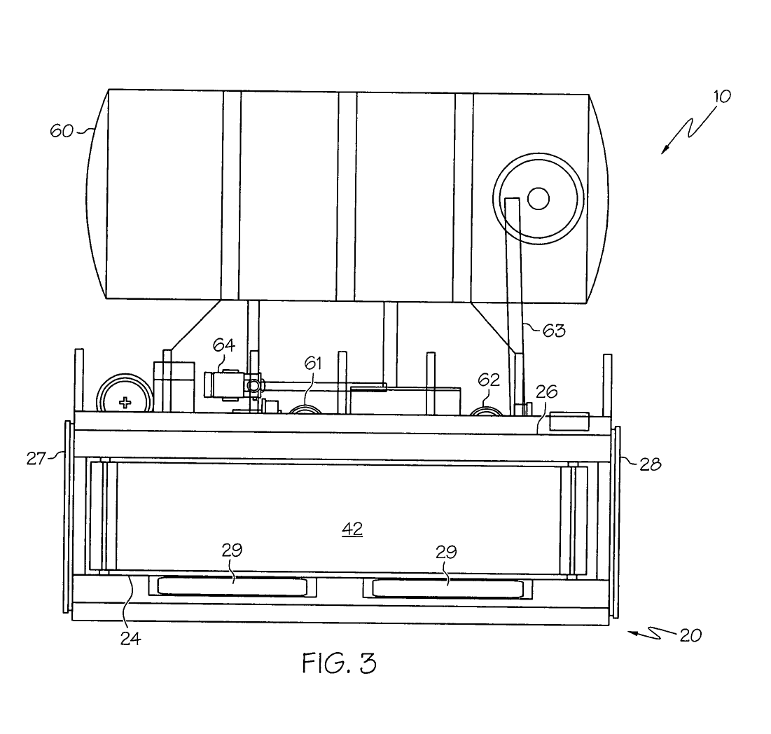

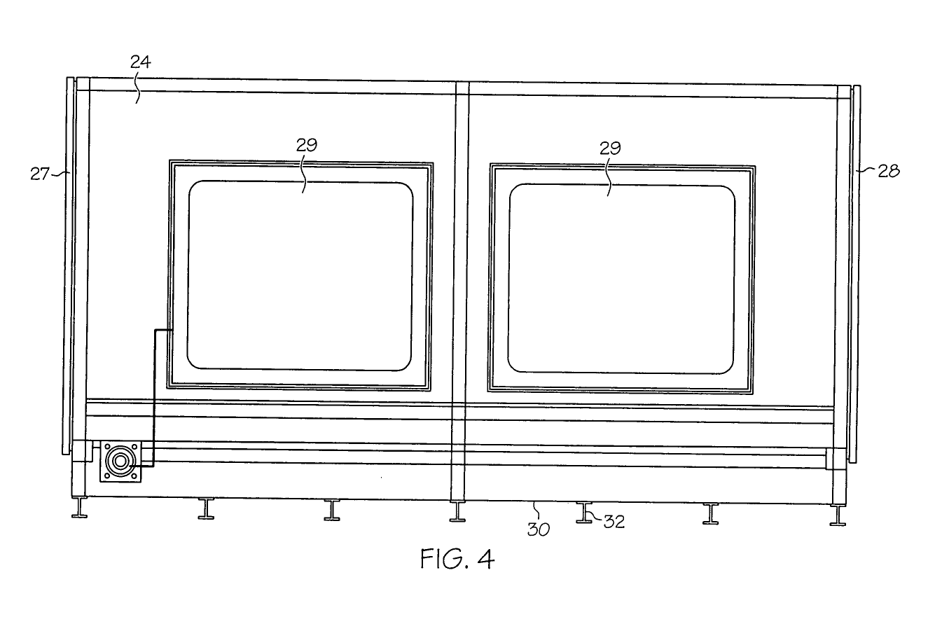

The present invention provides an aquatic conditioning and exercising device for animals (e.g., an aquatic treadmill). Referring to FIGS. 1-5, an exemplary embodiment of an aquatic treadmill 10 for a horse 1 is shown as generally including a container 20 configured to have a decreasing cross sectional area and a treadmill 40 positioned along a lower portion of the container such that upon entry into container 20, horse 1 will stand upon treadmill 40. Container 20 is configured or sized to contain a variety of size horses within a cavity 22 formed by container 20 such that such different size horses may stand or exercise upon treadmill 40 within container 20 and be partially submersed within a liquid contained within container 20.

In the exemplary embodiment, container 20 includes a bottom wall 30 formed from multiple girder I-bars 32 configured to form an I-bar structure and sheet metal (e.g., stainless steel) mounted to one side of the I-bar structure. The sheet metal forms an interior surface of container 20. I-bars 32 and the sheet metal are welded together to form bottom wall 30. It is understood that bottom wall 30, i.e., I-bars 32 and the sheet metal may be assembled and configured in a variety of ways and methods as known or yet-to-be discovered to one of ordinary skill in the art without departing from the spirit and scope of the present invention.

Container 20 may also include first and second sidewalls 24 and 26 connected to bottom wall 30 opposite from one another. First and second sidewalls 24 and 26, in the exemplary embodiment, extend upwardly from bottom wall 30 at an obtuse angle a. In the exemplary embodiment, angle a is from about 91 degrees to about 130 degrees. Angled sidewalls 24 and 26 provide for a decreasing cross section A of container 20 (forming cavity 22), i.e., a width (W) of cavity 22 disposed at an upper portion of container 20 decreases to a width (W₁) of cavity 22 disposed at a lower portion of container 20. The decreasing cross section A of container 20 provides for a decreased volume within container 20 (i.e., cavity 22). This decreased volume requires less liquid to either partially or completely fill container 20 (e.g., fill container 20 to a sufficient level to partially submerse a horse within cavity 22 of container 20) compared to conventional aquatic treadmills while still providing sufficient space in the upper portion of cavity 22 to contain the horse's torso. In an alternative exemplary embodiment, sidewalls 24 and 26 may be curved. For example, sidewalls 24 and 26 may be curved such that the sidewalls' curve substantially matches a portion of the curvature of the horse's torso.

First and second sidewalls 24 and 26, in the exemplary embodiment, are fabricated from a welded steel frame and a combination of sheet steel (e.g., stainless steel) and plastic are mounted on the steel frame. As shown in FIG. 1, the steel frame includes four corner posts 21 that are disposed in a substantially vertical orientation. Sidewalls 24 and 26 are connected at angle a to four corner posts 21. The vertical corner posts connected to the angled sidewalls provide container 20 with the desired reduced volume within cavity 22 and the necessary structural rigidity to retain 1,040 gallons of liquid within it. First and second sidewalls 24 and 26 are connected to bottom wall 30 such that these connections are a liquid tight seal. Optionally, one or both of first and second sidewalls 24 and 26 may have one or more transparent plastic windows 29 mounted within the steel frame comprising a substantial portion of the sidewall. The window(s) 29 are configured such that a person 2 may observe horse 1 exercising on treadmill 40. This is particularly beneficial for watching the gate of a horse (e.g., horse 1) that is recovering from an injury to see if the horse is favoring the injured appendage (e.g., leaning to one side due to a sore ankle) while exercising on treadmill 40.

Container 20 may also include first and second end doors 27 and 28 that are connected to at opposite ends of container 20. In the exemplary embodiment, end doors 27 and 28 are fabricated from a steel frame and transparent plastic mounted to one side of the steel frame. It is understood that the doors may comprise other materials and configurations as well, particularly the sheet material mounted to the steel frame. This sheet material may include, but not be limited to, plastic (e.g., transparent or opaque), sheet steel (e.g., stainless steel), and/or other materials. The end doors are movably connected to either one of first and second sidewalls 24 and 26 using any conventional or yet-to-be developed methods as known to one of ordinary skill in the art.

For example, the doors 27 and 28 may be hinged to either one of the first or second sidewalls 24 and 26 using multiple conventional hinges that enable the end doors 27 and 28 to move outwardly from container 20. Such outwardly movement of both end doors 27 and 28 allow horse 1 to enter into container 20 through one of the end doors (e.g., 27) and then exit through the opposite door (e.g., 28) without the horse having to be backed up to exit (e.g., either sufficient enough to open an inwardly, opening exit door or backwards out the entrance door, if only one door) the container. When the doors are in the closed position, the doors forms a liquid tight seal against bottom wall 22 and first and second sidewalls 24 and 26. The sidewalls 24 and 26, end doors 27 and 28, and bottom wall 30 form cavity 22 which has a capacity of approximately 1,040 gallons. In addition, doors 27 and 28 may include a locking mechanism to prevent the doors from unintentionally opening up. It is understood that the sidewalls, or for that matter, the entire container may be fabricated from a variety of materials, including but not limited to plastics, metals, composites, or a combination thereof.

In the exemplary embodiment, aquatic treadmill 10 is above ground. Such treadmill 10 may be configured to be portable, and as such, moved or transported from one position or site to another. In one alternative exemplary embodiment, treadmill 10 has a axle (not shown) mounted to the I-bars such that wheels may be mounted on the axle, allowing the treadmill to be escorted around to different sites. In still another alternative exemplary embodiment, treadmill 10 may be mounted onto a trailer (not shown) such that the aquatic treadmill 10 may be transported to a variety of sites for use.

Container 20 also includes an opening 50 disposed within one of its walls (e.g., first end door 27 or second end door 28) and a release door 52 that is configured to open or close opening 50. In the exemplary embodiment, opening 20 is disposed in a lower portion of one of the end doors (e.g., 27) and release door 52 is movably attached to container 20 such that it may move to sealingly engage or disengage opening 50. Release door 52 is also connected to a release handle (not shown). The release handle may be a variety of releases, handles, etc. as known to one of ordinary skill in the art. For example, the release handle may be a kick plate that may be actuated by an operator's foot. The release handle, when actuated by an operator, opens door 50, which releases a liquid retained within container 20 through opening 50. In one exemplary embodiment, opening 50 is configured to allow approximately 750 gallons to drain in 23 seconds or less. The release handle, door, and opening may be used during an emergency to quickly drain the liquid from container 20.

Aquatic treadmill 10 may include a mezzanine 70 positioned along a side of and/or connected to container 20. Such a mezzanine may be configured to allow one or more persons (e.g., observer 2) to stand upon mezzanine 70 along container 20 to observe horse 1 exercising upon treadmill 40 within container 20. Mezzanine 70 may be elevated from the floor along a sidewall of container 20, providing person 2 standing upon mezzanine 70 a view of or access to the horse exercising within container 20 over the sidewall.

As described above, Treadmill 40 is positioned along a lower portion of cavity 22 of container 20 such that when horse 1 enters container 20, the horse is standing upon treadmill 40. For example, treadmill 40 may be placed upon bottom wall 30 within cavity 22. Treadmill 40 may be any known or yet-to-be developed treadmill as known to one of ordinary skill in the art without departing from the spirit and scope of the present invention. In the exemplary embodiment, treadmill 40 may be configured to be submersible such that it may operate within a liquid (e.g., water) retained within container 20. Such a treadmill may include an endless belt 42 that may move in either direction (e.g., from first end door 27 to second end door 28 or vice versa).

Belt 42 may be movably mounted on a support surface (not shown). Such a support surface may be configured to both allow belt 42 to move from one end of container 20 to the opposite end and support a horse exercising upon belt 42. The support surface may comprise multiple rollers (not shown), a flat surface (not shown) that belt 42 may slide across, and/or any combination thereof. A motor 44 may be connected to treadmill 40 to drive a motor drive shaft 46, which moves belt 42 (e.g., via one of the rollers) from one end of container 20 to the opposite end. Motor 44 is configured to move belt 42 in either direction. Treadmill 40 may operate at variable speeds that can be controlled and/or adjusted. For example, in one exemplary embodiment, treadmill 40 may operate from about 0 mph to about 11 mph. Treadmill 40 may contain other components as known to one of ordinary skill in the art and need not be described herein.

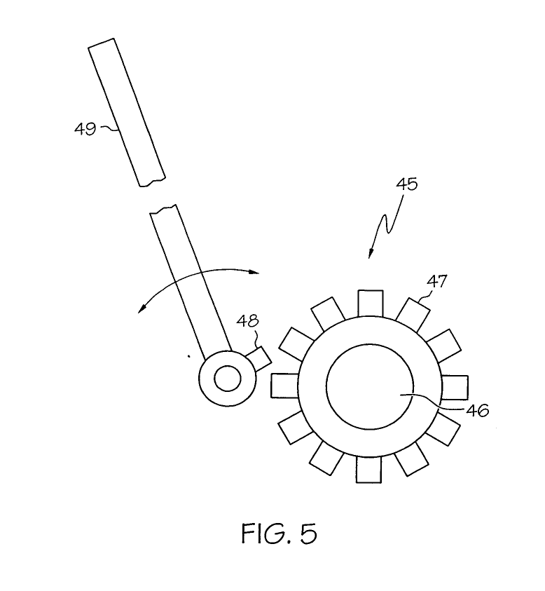

Referring to FIG. 5, a brake 45 may be configured to engage and lock treadmill 40 such that belt 42 is prevented from moving or shifting when horse 1 steps upon belt 42. In conventional treadmills, such movement often spooked or scared horses, making them afraid to continue to enter the treadmill and exercise within the container. In the exemplary embodiment, brake 45 may comprise a sprocket 47 attached to drive shaft 46 of treadmill 40 and a locking nub 48 attached to an actuator 49. An operator may operate actuator 49 such that nub 48 engages and locks into sprocket 47 before a horse enters container 20. When nub 48 is locked into sprocket 47, belt 42 is prevented from moving or shifting when the horse steps upon belt 42, thus keeping the horse from getting spooked. It is understood that brake 45 may comprise any device configured to prevent treadmill 40 without departing from the spirit and scope of the present invention.

Aquatic treadmill 10 may also include a storage tank 60 configured to store a quantity of a liquid (e.g., water) remote from container 20 and a pump connected to both tank 60 and container 20. The pump may be sized appropriately to pump the liquid from tank 60 to container 20 to partially and/or completely fill the container's cavity with the liquid. In the exemplary embodiment, the pump comprises two pumps: a drain pump 61 and a fill pump 62. The liquid level within container 20 may be controlled and/or adjusted to a variety of depths (e.g., allowing the liquid depth within container 20 to be adjusted for the height of the horse). Tank 60 and pumps 61 and 62 may be any type of tank and pump, conventional or yet-to-be developed, that are configured to store a liquid and pump it between the tank and the container without departing from the spirit and scope of the present invention. A variety of piping, connectors, valves, seals, plumbing configurations, etc., (e.g., 63) may be used for the plumbing that connects storage tank 60 to pump 62 and container 20 as known to one of ordinary skill in the art. In the exemplary embodiment, tank 60, pump 62, and plumbing 63 are configured to pump 1,040 gallons of water into container 20 in three minutes or less.

A filter assembly 64 (e.g., filter and filter pump) may also be connected to either container 20, tank 60, or somewhere in-between the two within the plumbing system 63 to filter out particulates (e.g., horse fecal matter, dirt, hair, etc.) from the liquid within the container. Such a filter assembly may be any conventional filter system as known to one of ordinary skill in the art. In an alternative embodiment, filter assembly 64 may comprise a centrifuge to filter out large particulate from the liquid before sending the liquid through a separate filter to separate out small particulate from the liquid. It is understood that a variety of filter configurations and systems may be used with the present invention without departing from the present invention's spirit and scope.

In the exemplary embodiment, aquatic treadmill 10 may be connected to a power source (not shown), either an AC source (e.g., 220-240 VAC, single phase) or DC source (e.g., battery). It is understood that treadmill 10 may also be configured to operate using other voltage combinations and/or a battery(s) without departing from the spirit and scope of the present invention. The power source may be electrically connected to a controller (not shown), which in turn, is electrically connected to motor 44, pumps 61 and 62, filter assembly 64, and optionally measurement devices (e.g., odometer, speedometer, temperature gauge(s), etc.), and control panel 66. Such a controller may be configured to operate aquatic treadmill 10 by allowing an operator to manipulate control panel 66 to control and/or monitor the power to treadmill 10 (e.g., On/Off switch), the speed of belt 42 (e.g., variable speed knob), the filling or draining of container 20 (e.g., Fill and Drain Button(s)), Odometer Readout, and Speedometer Readout.

The controller may also be connected via hardwire or wireless communications into a local or remote computer (not shown) to upload/download data to and from treadmill 10. This allows an operator to track the exercise regimen, progress, and/or results of each individual horse simply and efficiently. The computer may be connected into a LAN, WAN, wireless LAN, the internet, or other remote server allowing multiple treadmills and treadmill sites to be linked and data and programs to be uploaded/downloaded to and from the remote server to the multiple treadmills.

In the exemplary embodiment, bottom wall 30 is extended passed one of the sidewalls (e.g., passed first sidewall 24) such that the equipment (e.g., motor 44, pump 62, filter 64, control panel 66, etc.) may be placed upon bottom wall 30 next to container 20, making treadmill 10 substantially transportable, portable, and/or movable. It also makes aquatic treadmill 10 a relatively compact piece of equipment (e.g., space efficient). In the exemplary embodiment, treadmill 10 requires approximately a 10 foot by 10 foot area of floor space.

In operation, horse 1 is led through an end door (e.g., end door 27) into container 20 such that horse 1 is standing upon belt 42 of treadmill 40. The door (e.g., 27) is closed. An operator (e.g., operator/trainer 2) turns on pump 62 to pump water from tank 60 into cavity 22 of container 20. The container may be filled to a variety of levels but generally to a level sufficient to partially submerse the horse (e.g., at a level partially submersing the horse's torso). When the horse's torso is partially submersed, the buoyancy of the horse's body causes less of the horse's weight to be placed upon the horse's legs, thus reducing the on the horse's legs, joints, etc., due to impact when exercising. Once the liquid is at the desired level, the operator stops the pump and starts the treadmill (i.e., belt 42 begins to move), which causes the horse to begin to exercise upon the treadmill and within the water. The resistance of the water upon the horse causes the horse to get an increased workout within a shorter time period without the impact stress caused by exercise out of water. A trainer or other personnel (e.g., 2) may observe the horse's gate (e.g., walk, trot, canter, etc.) within the treadmill to see if the horse is favoring or overcorrecting for an injury. Once the exercise period is complete, the operator may hit the drain button on the control panel and pump 62 will drain the liquid from container 20 through filter 64 back into tank 60.

Accordingly, while some of the alternative embodiments of aquatic conditioning and exercising devices have been discussed specifically, other embodiments will be apparent or relatively easily developed by those of ordinary skill in the art. Accordingly, this invention is intended to embrace all alternatives, modifications and variations that have been discussed herein, and others that fall within the spirit and broad scope of the claims.

What is claimed is:

1. An aquatic treadmill for a horse, comprising:
a container configured to contain a horse partially within a retained liquid within said container, wherein said container comprises
first and second opposite end doors movably attached to said container and configured to move outwardly from said container; and
a treadmill positioned along a lower portion of said container comprising belt configured to move between said first and second opposite end doors to exercise a horse positioned thereupon and a drive system for driving said belt; and
a brake connected to said drive system and operable to lock said drive system in order to prevent said belt from moving when a horse steps upon said treadmill.

2. (canceled)

3. The aquatic treadmill according to claim 1, wherein said container comprises first and second opposite sidewalls positioned between said first and second end doors.

4. The aquatic treadmill according to claim 3, wherein at least one of said first and second sidewalls comprises a window configured to allow an observer positioned outside of said container to observe a horse exercising upon said treadmill.

5. The aquatic treadmill according to claim 1, wherein said first and second opposite end doors configured to move outwardly from said container such that a horse may enter one of said first and second doors and exit the other of said first and second doors without having to back up to exit.

6. The aquatic treadmill according to claim 1, wherein said first and second opposite end doors are partially transparent.

7. The aquatic treadmill according to claim 1, wherein said container is above ground level.

8. The aquatic treadmill according to claim 1, further comprising
a storage tank connected to said container and configured to store a liquid; and
a pump connected to said container and said tank and configured to circulate a liquid between both said container and said tank.

9. The aquatic treadmill according to claim 8, further comprising a filter device configured to filter a liquid as it flows from said container to said tank.

10. The aquatic treadmill according to claim 8, further comprising a heater configured to heat a liquid while in said tank.

11. The aquatic treadmill according to claim 1, further comprising
a motor configured to drive a belt of said treadmill between said first and second opposite doors; and
a controller configured to control the speed of said treadmill.

12. The aquatic treadmill according to claim 11, wherein said controller is configured to control the fill and drain of a liquid into or out of said container and the temperature of a liquid retained within said container.

13. The aquatic treadmill according to claim 1, further comprising:
an opening in a lower portion of said container;
a release door that sealingly engages said opening;
a release handle that is connected to said release door; and
wherein said handle is configured to open said release door to drain a liquid retained within said container.

14. The aquatic treadmill according to claim 1, further comprising a mezzanine disposed along said container, wherein said mezzanine is configured to enable a person to stand thereon and observe or access a horse exercising within said container.

15. The aquatic treadmill according to claim 3, further comprising:
a bottom wall having a plurality of girder I bars and sheet steel mounted on said I bars to form said bottom wall;
wherein said first and second sidewalls include a sidewall frame connected to said girder I bars and panels mounted upon said sidewall frame to form said sidewalls; and
wherein said treadmill is positioned upon said sheet steel of said bottom wall on the opposite side of said sheet steel from said girder I bars.

16. An aquatic treadmill for a horse, comprising:
a container configured to contain a horse partially submersed within a retained liquid within said container;
a treadmill positioned along a lower portion of said container, wherein said treadmill comprises an endless belt configured to move between an end of said container to an opposite end of said container to exercise a horse positioned thereupon and a drive system;
a brake connected to said drive system; and
a brake engagement device operable to engage said brake to lock said drive system and prevent sad belt from moving when a horse steps upon said treadmill.

17. The aquatic treadmill according to claim 16, wherein container comprises first and second sidewalls and at least one end door movably attached to one of said first and second sidewalls.

18. The aquatic treadmill according to claim 17, wherein said at least one end door is partially transparent.

19. An aquatic treadmill for a horse, comprising:
a container configured to retain liquid, wherein said container comprises
first and second opposite sidewalls, and
first and second opposite end doors movably attached to respective said first and second opposite sidewalls such that said doors move outwardly from said container;
a treadmill positioned along a lower portion of said container, said treadmill having an endless belt movable between said first and second opposite end doors;
a motor configured to drive said belt on said treadmill; and
a controller configured to operate said treadmill;
an opening in a lower portion of said container;
a release door sealingly engageable and movably connected to said opening;
a release handle that is connected to said release door; and
wherein said handle is configured to open said release door to drain a liquid retained within said container.

20. The aquatic treadmill according to claim 19, further comprising
a storage tank fluidly connected to said container and configured to store a liquid; and a pump configured to circulate a liquid between said container and said tank such that said container may be filled with 1,040 gallons of a liquid in a time period of less than or equal to 3 minutes.

21. The aquatic treadmill according to claim 1, wherein said brake comprises a sprocket connected to said drive system and a locking device movable to engage said sprocket in order to lock said drive system and prevent said belt from moving.
